(19) United States
(12) Patent Application Publication
(10) Pub. No.: US 2019/0253831 A1
(43) Pub. Date: Aug. 15, 2019

(54) METHOD OF BALANCE OF ACCURACY AND POWER CONSUMPTION FOR GEOFENCE

(71) Applicant: Futurewei Technologies, Inc., Plano, TX (US)

(72) Inventors: Jun Wang, Campbell, CA (US); Xinmin Ding, San Jose, CA (US); Xiaobo Wang, San Jose, CA (US); Zhijie Huo, Milpitas, CA (US)

(21) Appl. No.: 15/894,566

(22) Filed: Feb. 12, 2018

(51) Int. Cl. H04W 4/021; H04W 52/02; G01S 19/51

(52) U.S. Cl. CPC H04W 4/021; H04W 84/12; G01S 19/51; H04W 52/0251

(57) ABSTRACT

A location method in a communication network is provided. The method comprises a user equipment (UE) generating a geofence distance between a current UE location and a geofence, the UE comparing the geofence distance to a range threshold R, and the UE using a more accurate location determination when the geofence distance is less than the range threshold R.

### TECHNICAL FIELD

The present disclosure relates to location determination systems, and in particular to systems and methods for balance of accuracy and power consumption for a geofence.

### BACKGROUND

A geofence is a virtual perimeter for a real-world geographic area. A geofence can be dynamically generated, such as a radius around a store or point location, or it can be a predefined set of boundaries, like school attendance zones or neighborhood boundaries.

Smart phone applications (apps) may use a geofence to provide a virtual geographic boundary that enables software to trigger a response when a mobile device enters or leaves a particular area. If the apps attempt to maintain high location accuracy by using a global positioning system (GPS), power consumption will increase rapidly. To keep power consumption at an acceptable level, the accuracy of previous methods decrease to an unacceptable level.

### SUMMARY

Methods, apparatus, and systems are provided for location determination in a communication network. Various examples are now described to introduce a selection of concepts in a simplified form that are further described below in the detailed description. The Summary is not intended to identify key or essential features of the claimed subject matter, nor is it intended to be used to limit the scope of the claimed subject matter.

According to one aspect of the present disclosure, a location method in a communication network is provided. The method comprises a user equipment (UE) generating a geofence distance between a current UE location and a geofence, the UE comparing the geofence distance to a range threshold R, and the UE using a more accurate location determination when the geofence distance is less than the range threshold R.

Optionally, in any of the preceding aspects, the more accurate location determination has increased power consumption. Optionally, in any of the preceding aspects, the more accurate location determination comprises using a global positioning system (GPS). Optionally, in any of the preceding aspects, the UE using a less accurate location determination to determine the location when the geofence distance exceeds the range threshold R. Optionally, in any of the preceding aspects, the UE uses a cellular access point (AP) to determine the location when the geofence distance exceeds the range threshold R. Optionally, in any of the preceding aspects, the UE uses a WiFi access point (AP) to determine the location when the geofence distance exceeds the range threshold R. Optionally, in any of the preceding aspects, the UE uses a less frequent location determination rate GPS to determine the location when the geofence distance exceeds the range threshold R.

According to another aspect of the present disclosure, a location method in a communication network is provided. The method comprises a user equipment (UE) generating a geofence distance between a current UE location and a geofence, the UE comparing the geofence distance to a second range threshold P, and the UE comparing the geofence distance to a range threshold R when the geofence distance is less than the second range threshold P. The method further comprises the UE using a more frequent location determination when the geofence distance is less than the second range threshold P and when the geofence distance exceeds the range threshold R, and the UE using a more accurate location determination when the geofence distance is less than the second range threshold P and is less than the range threshold R.

Optionally, in any of the preceding aspects, the more accurate location determination has increased power consumption. Optionally, in any of the preceding aspects, the UE uses a more accurate and more frequent location determination when the geofence distance is less than the second range threshold P and is less than the range threshold R. Optionally, in any of the preceding aspects, the more accurate location determination comprises using a global positioning system (GPS). Optionally, in any of the preceding aspects, the UE uses a less accurate location determination to determine the location when the geofence distance exceeds the range threshold R. Optionally, in any of the preceding aspects, the UE uses a cellular access point (AP) to determine the location when the geofence distance exceeds the range threshold R. Optionally, in any of the preceding aspects, the UE using a WiFi access point (AP) to determine the location when the geofence distance exceeds the range threshold R. Optionally, in any of the preceding aspects, the UE using a less frequent location determination rate GPS to determine the location when the geofence distance exceeds the range threshold R.

According to another aspect of the present disclosure, a user equipment (UE) for location determination in a communication network is provided. The UE comprises a non-transitory memory storage comprising instructions and one or more processors in communication with the memory storage. The one or more processors execute the instructions to generate a geofence distance between a current UE location and a geofence, compare the geofence distance to a range threshold R, and use a more accurate location determination when the geofence distance is less than the range threshold R.

Optionally, in any of the preceding aspects, the more accurate location determination has increased power consumption. Optionally, in any of the preceding aspects, the more accurate location determination comprises using a global positioning system (GPS). Optionally, in any of the preceding aspects, the UE using a less accurate location determination to determine the location when the geofence distance exceeds the range threshold R. Optionally, in any of the preceding aspects, the UE uses a cellular access point (AP) to determine the location when the geofence distance exceeds the range threshold R. Optionally, in any of the preceding aspects, the UE uses a WiFi access point (AP) to determine the location when the geofence distance exceeds the range threshold R. Optionally, in any of the preceding aspects, the UE uses a less frequent location determination rate GPS to determine the location when the geofence distance exceeds the range threshold R.

According to another aspect of the present disclosure, a mobile electronic device for location determination in a communication network is provided. The mobile electronic device comprises a non-transitory memory storage comprising instructions and one or more processors in communication with the memory storage. The one or more processors execute the instructions to compare a geofence distance between a current UE location and a geofence, compare the geofence distance to a second range threshold P, and compare the geofence distance to a range threshold R when the geofence distance is less than the second range threshold P. The one or more processors further execute the instructions to use a more frequent location determination when the geofence distance is less than the second range threshold P and when the geofence distance exceeds the range threshold R, and use a more accurate location determination when the geofence distance is less than the second range threshold P and is less than the range threshold R.

Optionally, in any of the preceding aspects, the more accurate location determination has increased power consumption. Optionally, in any of the preceding aspects, the UE uses a more accurate and more frequent location determination when the geofence distance is less than the second range threshold P and is less than the range threshold R. Optionally, in any of the preceding aspects, the more accurate location determination comprises using a global positioning system (GPS). Optionally, in any of the preceding aspects, the UE uses a less accurate location determination to determine the location when the geofence distance exceeds the range threshold R. Optionally, in any of the preceding aspects, the UE uses a cellular access point (AP) to determine the location when the geofence distance exceeds the range threshold R. Optionally, in any of the preceding aspects, the UE using a WiFi access point (AP) to determine the location when the geofence distance exceeds the range threshold R. Optionally, in any of the preceding aspects, the UE using a less frequent location determination rate GPS to determine the location when the geofence distance exceeds the range threshold R.

Any one of the foregoing examples may be combined with any one or more of the other foregoing examples to create a new embodiment within the scope of the present disclosure.

This Summary is an overview of some of the teachings of the present application and not intended to be an exclusive or exhaustive treatment of the present subject matter. Further details about the present subject matter are found in the detailed description and appended claims The scope of the present inventive subject matter is defined by the appended claims and their legal equivalents.

### BRIEF DESCRIPTION OF THE DRAWINGS

FIG. 1 is a flow diagram illustrating a computer-implemented method for balance of accuracy and power consumption for a geofence, according to various embodiments.

FIG. 2 shows a wireless communication system including a base station (BS).

FIG. 3 is a flowchart of a location method in a communication network according to an embodiment.

FIG. 4 shows a wireless communication system.

FIG. 5 is a flowchart of a location method in a communication network according to an embodiment.

FIG. 6 illustrates a table for location determination for a system for balance of accuracy and power consumption for a geofence, according to various embodiments.

FIG. 7 is a block diagram illustrating the use of a method for balance of accuracy and power consumption for a geofence, according to various embodiments.

FIG. 8 is a diagram illustrating circuitry for implementing devices to perform methods according to an example embodiment.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the inventive subject matter, and it is to be understood that other embodiments may be utilized and that structural, logical and electrical changes may be made without departing from the scope of the present inventive subject matter. The following description of example embodiments is, therefore, not to be taken in a limited sense, and the scope of the present inventive subject matter is defined by the appended claims.

Smart phone apps can use a geofence to provide a virtual geographic boundary that enables software to trigger a response when a mobile device enters or leaves a particular area or crosses a geofence boundary. If the apps attempt to maintain high location accuracy by using a global positioning system (GPS), power consumption will increase rapidly. To keep power consumption at an acceptable level, previous methods decrease the location determination accuracy to an unacceptable level. For example, when the user device encounters a geofence, the user device may provide a message or display to the user, generate some manner of alert or indication, prompt the user to take a predetermined action, to log information, or to take any other action or response. If the geofence is related to a store or other commercial establishment, the geofence may prompt a display of product price, product availability, a price discount, or display a coupon or other information or action to entice the user to enter, stay, or purchase, for example.

The Android™ operating system already offers a geofence function. However, because of a low accuracy, many apps which need high accuracy and low power consumption cannot use the Android™ operating system geofence function directly. The Android™ operating system geofence function does not initiate GPS or other methods to get the current location, and instead queries the system to see a latest derived location. This location is queried by other Android™ apps, and can be recorded by the system, such that if no apps have queried the location recently, there will be no recent location in the system record. If there is no recent location records, Android™ will query the current location from the database using Wi-Fi AP or cellular tower information. Based on the geofence function provided by Android™, some apps add a “poll GPS” function to improve the accuracy, while other apps use Bluetooth® to improve accuracy. What is needed is an improved system and method for balance of accuracy and power consumption for a geofence.

The present subject matter uses different location sources (Wi-Fi, GPS, and Cellular Tower) and different location rates based on the proximity to the geofence boundary, wherein the geofence provides a virtual perimeter for a predetermined geographic area. When a user equipment (UE) is close to the geofence, i.e., within a predetermined distance from the fence, a more accurate location source and high rate are needed and provided. Farther away from the geofence, a less accurate location determination and an infrequent rate of location determination are chosen, to balance accuracy versus power consumption. This provides an improvement over existing methods by balancing locational accuracy and device power consumption.

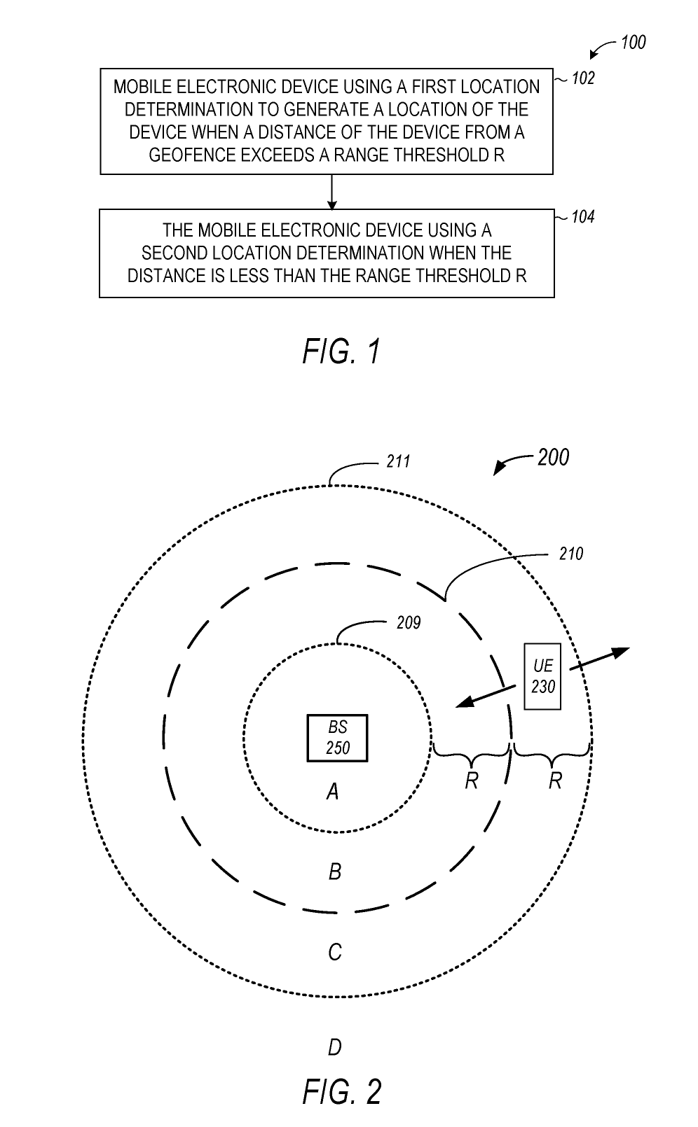

FIG. 1 is a flow diagram illustrating a computer-implemented method for balance of accuracy and power consumption in locating a geofence, according to various embodiments. In operation 102, the method includes a user equipment (UE), such as a mobile electronic device, uses a first location determination to determine a location of the UE when a geofence distance of the UE from the geofence exceeds a range threshold R. The first location determination comprises using a cellular AP, WiFi AP, and/or a less frequent location determination rate GPS to determine the location.

In operation 104, the UE uses a second location determination when the geofence distance is less than the range threshold R. The second location determination offers increased location accuracy, but at the cost of an increased power consumption compared to the first location determination.

According to some embodiments, the second location determination comprises using a more frequent location determination rate GPS to determine the location of the UE. The more frequent location determination rate refers to an increased rate of location determinations requested and/or received by the UE, such as a normal or more frequent GPS location determination rate. According to some embodiments, the first location determination employs a normal location determination rate GPS when the geofence distance of the UE from the geofence is less than a second distance threshold, wherein the second distance threshold is greater than the first distance threshold.

The method further includes the UE using the first location determination when the geofence distance exceeds the first distance threshold but is less than a second distance threshold, and the UE using a third location determination when the geofence distance exceeds the first distance threshold and exceeds the second distance threshold, wherein the second distance threshold is greater than the first distance threshold, in various embodiments. The method further includes the UE using the first location determination when the geofence distance exceeds the first distance threshold but is less than a second distance threshold, with the first location determination comprising using a normal location determination rate GPS to determine the location of the UE, and the UE using a third location determination when the geofence distance exceeds the first distance threshold and exceeds the second distance threshold, with the third location determination comprising using a less frequent location determination rate GPS (or lower than the normal rate) to determine the location, wherein the second distance threshold is greater than the first distance threshold, in some embodiments. According to some embodiments, when the UE is inside the geofence, the first location determination is received from a WiFi AP. When the UE is outside the geofence, the first location determination is received from a WiFi AP, a cellular AP, or a less frequent location determination rate GPS, according to some embodiments.

Using a known or approximate geofence location, the present subject matter divides an area around a geofence into zones and uses particular location determination systems based on the zone where the UE is located, based on known positional information. In general, the closer to the geofence, a more accurate location source and a high location determination rate are chosen, and farther away from the geofence, a less accurate location determination and a less frequent location determination rate are chosen, to balance the accuracy and power consumption.

FIG. 2 shows a wireless communication system 200 including a base station (BS) 250. The base station 250 can comprise a base station that performs and facilitates communications according to any wireless or cellular communication system or protocol, including CDMA, 2G, 3G, 4G, or 5G systems, for example The base station 250 can further include a Wi-Fi^{RM} or Bluetooth^{RM} transmitter or transceiver in some embodiments. Further, the base station 250 can provide more than one communication type/protocol, such as both cellular communications and Wi-Fi communications. Alternatively, the BS 250 can provide cellular and Bluetooth^{RM} communications.

The base station 250 can communicate with a user equipment (UE) 230 when the UE 230 is within a geographic area served by the base station 250. Further, the UE 230 can determine its own approximate position within the geographic area served by the base station 250. As shown in the figure, the UE 230 can move toward or away from the base station 250, and can move in any direction.

The figure further shows a geofence 210, an inner range threshold R 209, and an outer range threshold R 211. The geofence 210 represents an imaginary boundary or divider. When the geofence 210 is present, the UE 230 determines the location of the geofence 210 based on the UE's own geographic location. Similarly, through location information, the UE 230 can detect a crossing of the geofence 210.

The inner range threshold R 209 and the outer range threshold R 211 extend a predetermined distance R from the geofence 210. The inner range threshold R 209 and the outer range threshold R 211 represent a zone around the geofence 210 where the UE 230 uses a higher accuracy location determination in some embodiments. The inner range threshold R 209 and the outer range threshold R 211 represent a zone where the UE 230 uses a higher rate or frequency of location determination in some embodiments. The inner range threshold R 209 and the outer range threshold R 211 represent a zone where the UE 230 uses both a higher accuracy location determination and a higher rate of location determination in some embodiments.

This scenario provides at least two different location determination accuracies. This scenario provides at least two different power consumption levels.

In the example shown, the geofence 210, the inner range threshold R 209, and the outer range threshold R 211 generate zones A, B, C, and D. Zone A comprises an area or region inside the inner range threshold R 209. Zone B comprises an area or region between the inner range threshold R 209 and the geofence 210. Zone C comprises an area or region between the geofence 210 and the outer range threshold R 211. Zone D comprises everything outside the outer range threshold R 211. In this example, the UE 230 uses either a lower accuracy or a lower location determination rate when in Zone D, uses either a higher accuracy or a higher location determination rate when in Zone C, uses either a higher accuracy or a higher location determination rate when in Zone B, and uses either a lower accuracy or a lower location determination rate when in Zone A. Therefore, it can be seen that the UE 230 uses a higher accuracy or a higher location determination rate when in Zones B or C, on either side of (and in closer proximity to) the geofence 210.

In some embodiments, the UE 230 uses a less accurate location determination to determine the location when the geofence distance exceeds the range threshold R. In these embodiments, the UE 230 uses the less accurate location determination when in zone A or when in zone D. Alternatively, in other embodiments the UE 230 uses a less accurate location determination to determine the location when the geofence distance exceeds the range threshold R and the UE 230 is inside an area surrounded by the geofence 210. In these embodiments, the UE 230 uses the less accurate location determination when in zone A.

In some embodiments, the UE 230 detects a relative distance to the geofence 210. When the UE 230 is relatively distant from the geofence 210, the accuracy of the position information is relatively unimportant. According to various embodiments, in zone A, when the UE 230 detects the BS 250 as a Wi-Fi AP, it can be inferred that the user is at a target place or area. Because the operating system (OS) of the UE 230 frequently scans Wi-Fi AP (when Wi-Fi is enabled), no extra power consumption is needed to obtain location information from the BS 250. In some cases, zone A may be in a building and may have a weak or lost GPS signal. Using available Wi-Fi AP information, the lack of GPS can be avoided. However, as the UE 230 approaches the geofence 210, from either side or in any direction (orthogonally or obliquely), then the accuracy of the position information obtained by the UE 230 becomes more important. This comprises zones B-C.

In zone C, because the need for accuracy is less, the BS 250 (or cellular AP) and public Wi-Fi AP information can be used for obtaining the location information.

In some embodiments, the UE 230 only needs to obtain approximate or low accuracy location information when farther away from the geofence 210 than a predetermined threshold comprising the range threshold R. Alternatively, or in addition, the UE 230 can obtain position information at a lower rate or frequency (i.e., every minute versus every thirty seconds) when outside the threshold. Conversely, when the UE 230 is less than the predetermined distance from the threshold from the geofence 210, then the UE will require a higher positional accuracy to accurately locate the geofence 210. As a result, when the UE 230 is less than the range threshold R from the geofence 210, the UE 230 may require better location information. This can be achieved when the UE 230 obtains location information of greater accuracy. This can be achieved when the UE 230 obtains location information at a higher rate or frequency, such as shifting from a location determination rate of once about every five seconds when outside the range threshold R to a location determination rate of about less than one second apart. This example is given for illustration only, and is not necessarily reflective of an actual update timing. By using a location information derived in various ways, the UE 230 can locate the position of the geofence 210 with greater accuracy, while requiring expenditure of less electrical power.

When the UE 230 approaches the geofence 200 from either direction, i.e., traveling inwardly toward the BS 250 or outwardly away from the BS 250, the location determination performed by the UE 230 will change when the UE 230 moves within a range threshold R of the geofence 210. By changing the location determination performed by the UE 230, the geofence location determination can be performed using an overall less electrical power.

By changing the location determination performed by the UE 230, the geofence location determination can be performed without compromising accuracy when the UE 230 is close to or near the geofence 210.

In some examples, the UE 230 uses a GPS location determination when within the range threshold R from the geofence 210.

In some examples, the UE 230 uses an alternative lower power, lower accuracy location determination when outside the range threshold R from the geofence 210. The UE 230 does not need a more accurate, more costly location determination when the UE 230 is too far from the geofence 210 to need a highly accurate location determination.

The UE 230 can be outside the range threshold R when inside the geofence 210, when outside the geofence 210, or both.

In some examples, the UE 230 uses an alternative lower power, lower accuracy location determination at a normal or increased location determination rate (or frequency) when outside the range threshold R from the geofence 210. The more frequent location determination at the higher rate or frequency will provide a better, more accurate location determination. The location determination performed at the higher rate or frequency will generally consume more electrical power.

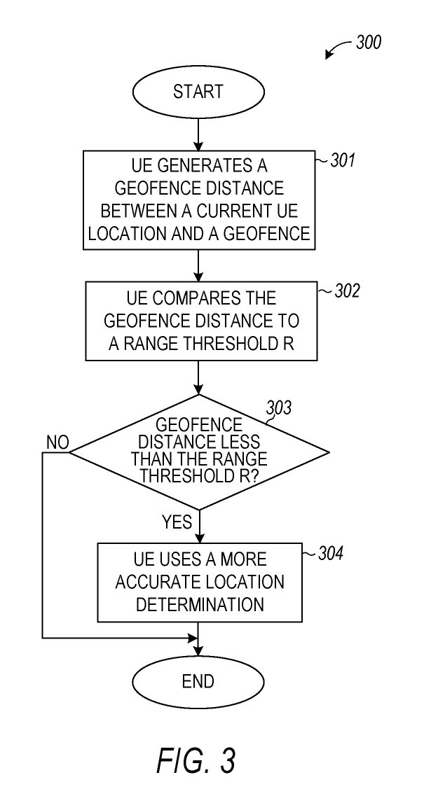

FIG. 3 is a flowchart 300 of a location method in a communication network according to an embodiment. The method balances location accuracy and electrical power consumption. The method is performed by a UE (or other mobile electronic device) in some examples.

In step 301, the UE (or other mobile electronic device) generates a geofence distance between a current UE location and a geofence. The current UE location comprises location information currently available to the UE, wherein the UE needs to obtain a new or updated location in order to ensure that the UE properly detects the geofence and can accurately determine when the UE approaches and/or crosses the geofence. The UE may also have geofence location information or some manner of information that specifies where the geofence should be observed to exist. The geofence distance therefore comprises a distance of the UE from the geofence, and is typically the distance to a nearest portion of the geofence.

In step 302, the UE compares the geofence distance to a range threshold R. The range threshold R comprises a distance from the geofence where the UE can or should change a location determination being used by the UE. The range threshold R can therefore be selected according to desired accuracy and power consumption characteristics of the location determination for the UE.

In step 303, if the geofence distance is less than the range threshold R, then the UE determines that it is inside the range threshold R, i.e., the UE is within a zone or area where a better location determination is desired. Conversely, if the geofence distance is greater than the range threshold R, then the UE determines that a less accurate and/or lower power consumption location determination should be used, as the location determination is of less importance outside of the range threshold R.

In step 304, because the geofence distance is less than the range threshold R, the UE uses the better location determination to obtain a new or updated location determination. As previously discussed, the better location determination can include a higher accuracy location determination, an increased rate of location determination, or both.

It should be understood that when the UE is within the range threshold R from the geofence, the UE will continue to use the better location determination. If the UE moves away from the geofence to where the geofence distance exceeds the range threshold R, then the UE will switch to the lesser location determination. Similarly, the UE will switch back to the better location determination if the UE moves from outside the range threshold R to inside the range threshold R.

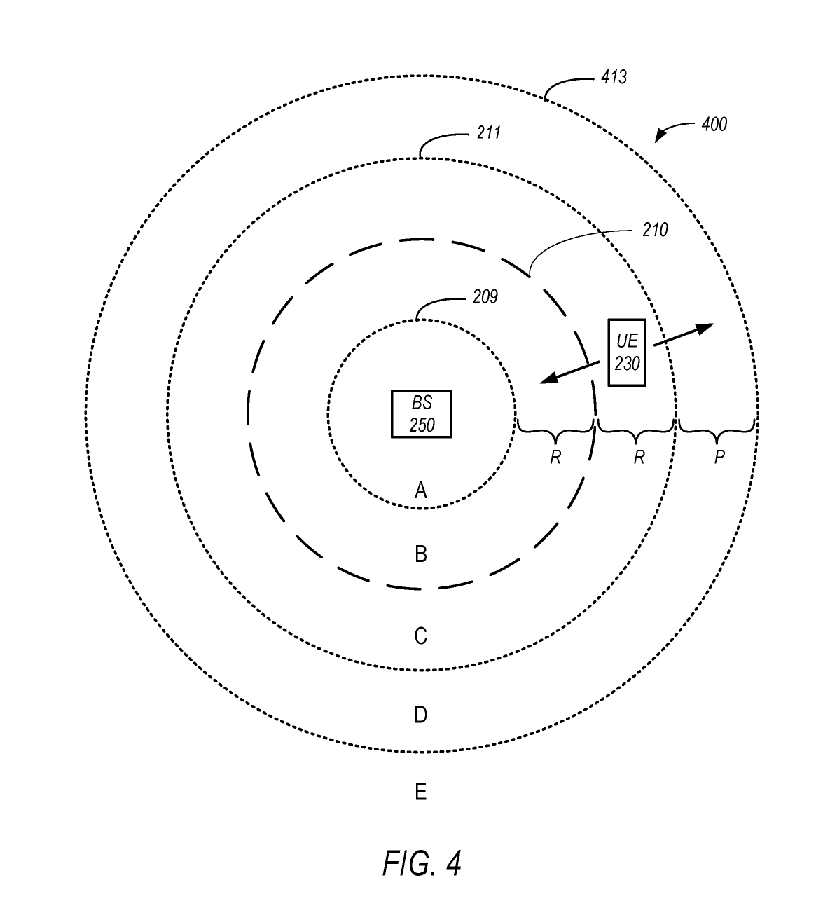

FIG. 4 shows a wireless communication system 400. The wireless communication system 400 includes components similar to the wireless communication system 200 of FIG. 2, with the addition of a second range threshold P 413. In this example, the second range threshold P 413 is farther out from the geofence 210 than the range threshold R 211. In some examples, the second range threshold P 413 is used by the UE 230 to change a rate or frequency of performing the location determinations. This scenario provides at least three different location determination accuracies and power consumption levels.

If the UE 230 is outside the geofence 210 and is moving outwardly and away from the geofence 210, then when the UE 230 exceeds the outer range threshold R 211, the UE 230 can switch from a high accuracy location determination to a relatively lower accuracy location determination. Similarly, if the UE 230 continues its outward movement, when the UE 230 exceeds the second range threshold P 413, the UE 230 can switch from a frequent location determination rate to an infrequent location determination rate.

This scenario provides at least two different power consumption levels and at least two different location determination rates. In the example shown, the geofence 210, the inner range threshold R 209, the outer range threshold R 211, and the second range threshold P 413 generate zones A, B, C, D, and E.

Zone A comprises an area or region inside the inner range threshold R 209. Zone B comprises an area or region between the inner range threshold R 209 and the geofence 210. Zone C comprises an area or region between the geofence 210 and the outer range threshold R 211. Zone D comprises an area or region between the outer range threshold R 211 and the second range threshold P 413. Zone E comprises everything outside the second range threshold P 413.

In some embodiments, the UE 230 uses a less accurate location determination to determine the location when the geofence distance exceeds the range threshold R. In these embodiments, the UE 230 uses the less accurate location determination when in zone A or when in zones D and E. Alternatively, in other embodiments the UE 230 uses a less accurate location determination to determine the location when the geofence distance exceeds the range threshold R (209 and 211) and exceeds the second range threshold P 413. In these embodiments, the UE 230 uses the less accurate location determination when in zone A or when in zone E. Alternatively, in yet other embodiments the UE 230 uses a less accurate location determination to determine the location when the geofence distance exceeds the range threshold R and the UE 230 is inside an area surrounded by the geofence 210. In these embodiments, the UE 230 uses the less accurate location determination when in zone A.

In this example, the UE 230 uses both a lower accuracy and a lower location determination rate when in zone E, uses a lower accuracy and a higher location determination rate when in zone D, and uses both a higher accuracy and a higher location determination rate when in zones B and C. The UE 230 can use a higher accuracy and a lower location determination rate when in zone A. Therefore, it can be seen that the UE 230 uses a both a higher accuracy and a higher location determination rate when in zones B or C, on either side of (and in closer proximity to) the geofence 210. When in zone D, the UE 230 uses a higher accuracy location determination, but at a lower determination rate.

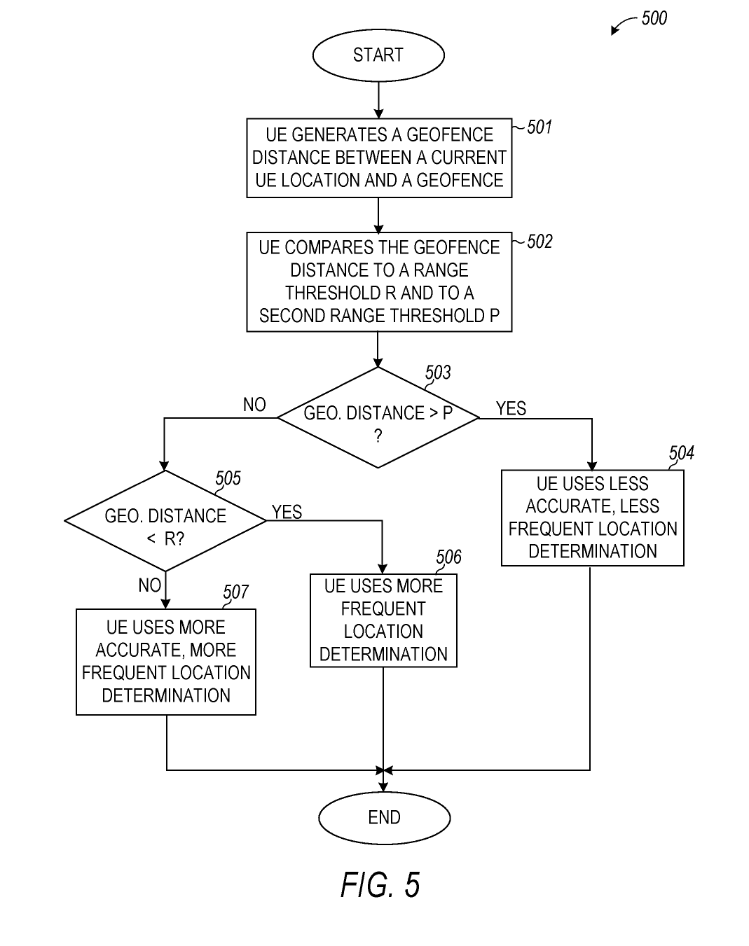

FIG. 5 is a flowchart 500 of a location method in a communication network according to an embodiment. The method 500 balances location accuracy and electrical power consumption. The method 500 is performed by a UE (or other mobile electronic device) in some examples.

In step 501, the UE (or other mobile electronic device) generates a geofence distance between a current UE location and a geofence, as previously discussed.

In step 502, the UE compares the geofence distance to both a range threshold R and a second threshold P. The range threshold R comprises a distance from the geofence where the UE uses a more accurate location determination, as previously discussed. The second threshold P comprises a distance from the geofence where the UE uses an increased rate of location determination, as previously discussed. The second threshold P is larger than the range threshold R in the embodiment shown. The second threshold P is used to increase the rate of location determination as the UE approaches the geofence, before increasing the accuracy of the location by changing the source of the location determination.

In step 503, if the geofence distance is greater than the second threshold P, then the method branches to step 504. Otherwise, where the geofence distance is less than the second threshold P, the method branches to step 505.

In step 504, because the geofence distance is greater than the second threshold P, the UE uses a less frequent rate of location determination. As a result, when the geofence distance is greater than the second threshold P, the UE uses a lower accuracy location determination and also uses a less frequent rate of location determination. As a result, the UE has determined that a lower electrical power consumption is appropriate, due to the relatively large distance to the geofence. Accuracy of the location determination is not needed in this condition.

In step 505, if the geofence distance is less than the range threshold R, then the method branches to step 507. Otherwise, where the geofence distance is greater than the range threshold R, the method branches to step 506.

In step 506, where the geofence distance is less than the second threshold P and is greater than the range threshold R (i.e., the UE is in zone D of FIG. 4), then the UE uses an increased rate of location determination. The UE, however, still uses a less accurate location determination.

In step 507, where the geofence distance is less than the second threshold P and is also less than the range threshold R (i.e., the UE is in zone C or zone B of FIG. 4), then the UE uses both the greater accuracy location determination and uses an increased rate of location determination. Alternatively, the UE can use the greater accuracy location determination, but a decreased rate of location determination.

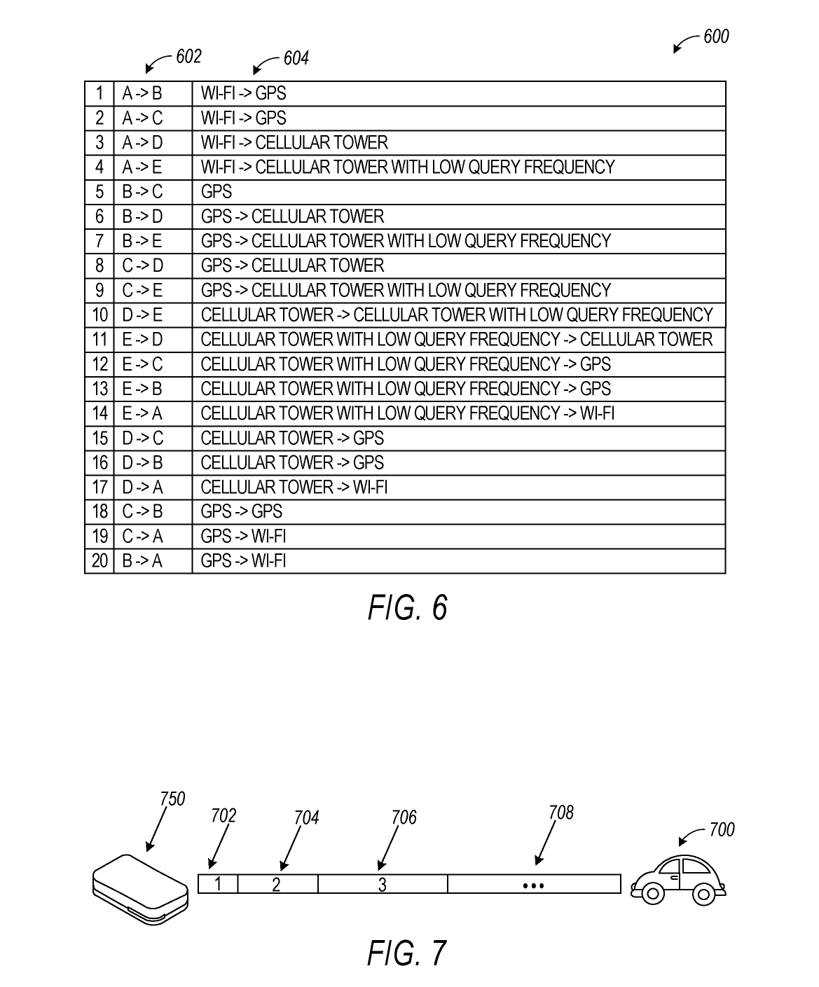

FIG. 6 is a table 600 that illustrates location determination in a system, enabling the balancing of accuracy and power consumption when locating a geofence, according to at least some of the embodiments disclosed herein. The table provides an embodiment for switching the type of location services and frequency of query of the location services, based on crossing a boundary in the embodiment of FIG. 2. In column 602 of the table 600, a transition across a boundary in a direction is listed, and in column 604 of the table 600, the corresponding location determination switching is indicated. For example, in the first row of the table, the user is determined to have crossed from zone A to zone B (see column 602), in which case the UE 230 switches from using WiFi to using GPS for location determination (see column 604). In this manner, location determination accuracy is increased closest to the geofence 210, and decreased further from the geofence 210 to conserve power.

FIG. 7 is a block diagram illustrating the use of a method for balance of accuracy and power consumption for a geofence, according to various embodiments. In the depicted embodiment, a user is in a moving vehicle 700 and crosses into areas 708, 706, 704 and 702 while approaching a geofence boundary near a router 750. The router 750 is optionally included in various embodiments. As the vehicle crosses boundaries between areas, the present subject matter uses a different location source (Wi-Fi, GPS, and/or cellular Tower) and different query frequency based on these areas. In general, closer to the geofence boundary, a more accurate location source and high frequency are chosen, and farther away from geofence boundary, a less accurate source and lower frequency are chosen to balance the accuracy and power consumption.

According to different accuracy requirements based on distance from the range line (or geofence boundary), the present subject matter uses different method to retrieve location information based on different distances from the range line. Beyond a predetermined distance from the range line, a lower query frequency is used to reduce power consumption for the electronic device. If at any time a signal cannot be acquired by the device (WiFi or cellular, etc.), the present subject matter will switch to another location determination device until the location can be successfully determined.

In one embodiment, a method includes using a mobile electronic device to provide multiple geographic zones for use with a geofence boundary, including a first geographic zone closest to a target place, a second geographic zone outside the first geographic zone but inside the geofence boundary, a third geographic zone outside the geofence boundary, a fourth geographic zone that is outside the third geographic zone, and a fifth geographic zone that is outside the fourth geographic zone. The mobile electronic device is used to determine location of the device based on which of the multiple geographic zones the device is located within in a previous location determination, including: in the first geographic zone, using a wireless (Wi-Fi) signal to determine location; in the second and third geographic zones, using a global positioning system (GPS) to determine location and to determine whether the device has crossed the boundary; in the fourth geographic zone, using cellular tower information to determine location; and in the fifth geographic zone, using cellular tower information to determine location, and using a reduced location query frequency than is used in the third geographic zone.

In various embodiments, the multiple geographic zones (areas) are defined in a lookup table. The multiple geographic zones are dynamically defined, in various embodiments. The multiple geographic zones are defined based on detected movement of the device, in an embodiment. The mobile electronic device can include a cellular telephone, a tablet, a GPS device (in a vehicle or hand-held), or other device.

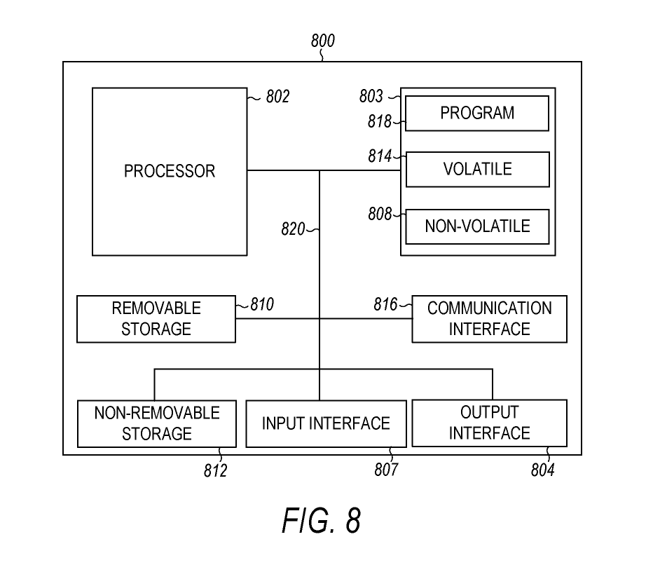

FIG. 8 is a schematic diagram illustrating circuitry for performing methods according to example embodiments. All components need not be used in various embodiments. For example, the computing devices may each use a different set of components and storage devices.

One example computing device in the form of a computer 800 may include a processor 802, memory 803, removable storage 810, and non-removable storage 812, all coupled by a bus 820. Although the example computing device is illustrated and described as computer 800, the computing device may be in different forms in different embodiments. For example, the computing device, or mobile electronic device, may instead be a smartphone, a tablet, smartwatch, router, or other computing device including the same or similar elements as illustrated and described with regard to FIG. 8. Devices such as smartphones, tablets, and smartwatches are generally collectively referred to as mobile devices. Further, although the various data storage elements are illustrated as part of the computer 800, the storage may also or alternatively include cloud-based storage accessible via a network, such as the Internet or server-based storage.

In FIG. 8, memory 803 may include volatile memory 814 and/or non-volatile memory 808. Computer 800 may include—or have access to a computing environment that includes—a variety of computer-readable media, such as volatile memory 814 and/or non-volatile memory 808, removable storage 810 and/or non-removable storage 812. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions. Storage can also include networked storage such as a storage area network (SAN).

Computer 800 may include or have access to a computing environment that includes an input interface 807, an output interface 804, and a communication interface 816. In various embodiments, communication interface 816 includes a transceiver and an antenna. Output interface 804 may include a display device, such as a touchscreen, that also may serve as an input device. The input interface 807 may include one or more of a touchscreen, touchpad, mouse, keyboard, camera, one or more device-specific buttons, one or more sensors integrated within or coupled via wired or wireless data connections to the computer 800, or other input devices. The computer 800 may operate in a networked environment using a communication connection to connect to one or more remote computers, such as database servers. The remote computer may include a personal computer (PC), server, router, network PC, a peer device or other common network node, or the like. The communication connection may include a Local Area Network (LAN), a Wide Area Network (WAN), cellular, WiFi, Bluetooth®, or other networks.

Computer-readable instructions, i.e., a program 818, comprises instructions stored on a computer-readable medium that are executable by the processor 802 of the computer 800. The terms “computer-readable medium” and “storage device” do not include carrier waves to the extent carrier waves are deemed too transitory. In one example, the processor 802 executes the program 818 to implement methods for balance of accuracy and power consumption for a geofence. Various embodiments use a look-up table for this purpose, such as table 600 in FIG. 6.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

Although the present disclosure has been described with reference to specific features and embodiments thereof, it is evident that various modifications and combinations can be made thereto without departing from the scope of the disclosure. The specification and drawings are, accordingly, to be regarded simply as an illustration of the disclosure as defined by the appended claims, and are contemplated to cover any and all modifications, variations, combinations or equivalents that fall within the scope of the present disclosure.

1. A location method in a communication network, comprising:
a user equipment (UE) generating a geofence distance between a current UE location and a geofence;
the UE comparing the geofence distance to a range threshold R; and
the UE using a more accurate location determination when the geofence distance is less than the range threshold R.

2. The method of claim 1, with the more accurate location determination having increased power consumption.

3. The method of claim 1, with the more accurate location determination comprising using a global positioning system (GPS).

4. The method of claim 1, further comprising the UE using a less accurate location determination to determine the location when the geofence distance exceeds the range threshold R.

5. The method of claim 1, further comprising the UE using a cellular access point (AP) to determine the location when the geofence distance exceeds the range threshold R.

6. The method of claim 1, further comprising the UE using a WiFi access point (AP) to determine the location when the geofence distance exceeds the range threshold R.

7. The method of claim 1, further comprising the UE using a less frequent location determination rate GPS to determine the location when the geofence distance exceeds the range threshold R.

8. A location method in a communication network, comprising:
a user equipment (UE) generating a geofence distance between a current UE location and a geofence;
the UE comparing the geofence distance to a second range threshold P;
the UE comparing the geofence distance to a range threshold R when the geofence distance is less than the second range threshold P;
the UE using a more frequent location determination when the geofence distance is less than the second range threshold P and when the geofence distance exceeds the range threshold R; and
the UE using a more accurate location determination when the geofence distance is less than the second range threshold P and is less than the range threshold R.

9. The method of claim 8, with the more accurate location determination having increased power consumption.

10. The method of claim 8, with the UE using a more accurate and more frequent location determination when the geofence distance is less than the second range threshold P and is less than the range threshold R.

11. The method of claim 8, with the more accurate location determination comprising using a global positioning system (GPS).

12. The method of claim 8, further comprising the UE using a less accurate location determination to determine the location when the geofence distance exceeds the range threshold R.

13. The method of claim 8, further comprising the UE using a cellular access point (AP) to determine the location when the geofence distance exceeds the range threshold R.

14. The method of claim 8, further comprising the UE using a WiFi access point (AP) to determine the location when the geofence distance exceeds the range threshold R.

15. The method of claim 8, further comprising the UE using a less frequent location determination rate GPS to determine the location when the geofence distance exceeds the range threshold R.

16. A user equipment (UE), comprising:
a non-transitory memory storage comprising instructions; and
one or more processors in communication with the memory storage, wherein the one or more processors execute the instructions to:
generate a geofence distance between a current UE location and a geofence;
compare the geofence distance to a range threshold R; and
use a more accurate location determination when the geofence distance is less than the range threshold R.

17. The UE of claim 16, with the more accurate location determination having increased power consumption.

18. The UE of claim 16, with the more accurate location determination comprising using a global positioning system (GPS).

19. The UE of claim 16, further comprising the UE using a less accurate location determination to determine the location when the geofence distance exceeds the range threshold R.

20. The UE of claim 16, further comprising the UE using a cellular access point (AP) to determine the location when the geofence distance exceeds the range threshold R.

21. The UE of claim 16, further comprising the UE using a WiFi access point (AP) to determine the location when the geofence distance exceeds the range threshold R.

22. The UE of claim 16, further comprising the UE using a less frequent location determination rate GPS to determine the location when the geofence distance exceeds the range threshold R.

23. A user equipment (UE), comprising:
a non-transitory memory storage comprising instructions; and
one or more processors in communication with the memory storage, wherein the one or more processors execute the instructions to:
compare a geofence distance between a current UE location and a geofence;
compare the geofence distance to a second range threshold P;
compare the geofence distance to a range threshold R when the geofence distance is less than the second range threshold P;
use a more frequent location determination when the geofence distance is less than the second range threshold P and when the geofence distance exceeds the range threshold R; and
use a more accurate location determination when the geofence distance is less than the second range threshold P and is less than the range threshold R.

24. The UE of claim 23, with the more accurate location determination having increased power consumption.

25. The UE of claim 23, with the UE using a more accurate and more frequent location determination when the geofence distance is less than the second range threshold P and is less than the range threshold R.

26. The UE of claim 23, with the more accurate location determination comprising using a global positioning system (GPS).

27. The UE of claim 23, further comprising the UE using a less accurate location determination to determine the location when the geofence distance exceeds the range threshold R.

28. The UE of claim 23, further comprising the UE using a cellular access point (AP) to determine the location when the geofence distance exceeds the range threshold R.

29. The UE of claim 23, further comprising the UE using a WiFi access point (AP) to determine the location when the geofence distance exceeds the range threshold R.

30. The UE of claim 23, further comprising the UE using a less frequent location determination rate GPS to determine the location when the geofence distance exceeds the range threshold R.
